(19) United States
(12) Patent Application Publication
(10) Pub. No.: US 2001/0029485 A1
(43) Pub. Date: Oct. 11, 2001

(54) Systems and methods enabling anonymous credit transactions

(75) Inventors: Robert M. Brody, Weston, CT (US); Reuben S. Kennedy, Duluth, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E-Scoring, Inc.

(21) Appl. No.: 09/796,719

(22) Filed: Feb. 28, 2001

Related U.S. Application Data
(60) Provisional application No. 60/186,166, filed on Feb. 29, 2000.

(51) Int. Cl. G06F 17/60; H04K 1/00

(52) U.S. Cl. 705/39; 705/75

(57) ABSTRACT

The system and method of the present invention enables consumers to purchase goods and services from merchants, using credit cards, wherein the consumers can maintain the confidentiality of their credit card numbers and identity without disclosure to the merchants, so that an anonymous credit transaction can take place. The system and method takes blocks of consumer credit card numbers and creates dynamic mappings of the card numbers to account numbers or even other card numbers, such as pseudo-random credit card numbers. The system and method of the present invention generates pseudo-random credit card attributes, which are presented to merchants at the time of purchase for Internet, telephone, or mail order purchases. Because pseudo-random attributes are transmitted to the merchant, the transaction between the consumer and merchant will be anonymous. Pseudo-random attributes include the card number, name, billing zip code, expiration date, and purchase amount, each of which can be used singularly or in combination to authenticate a transaction according to consumer preferences, which are captured when the consumer establishes the agent relationship with system of the present invention.

### RELATED APPLICATION DATA

The present application claims priority from U.S. Provisional Patent Application Serial No. 60/186,166, filed Feb. 29, 2000, titled “Systems and Methods Enabling Anonymous Credit Transactions” and assigned to E-Scoring, Inc., the entire contents of which are herein incorporated by reference.

### FIELD OF THE INVENTION

The present invention relates to electronic payments in exchange for goods and services, and more specifically, to systems and methods enabling consumers to purchase goods and services from merchants using credit cards.

### BACKGROUND OF THE INVENTION

Shopping for goods and services using a personal computer to place an order on a network, such as the Internet, has exploded in volume over the past few years due to the ever increasing number of merchants selling goods and services via the Internet, as well as the increasing number of consumers online. Online shopping, which is a natural extension to the more traditional catalog shopping, enables consumers to quickly and efficiently browse through goods at their favorite online stores without leaving the comfort of their own home. The advantages of such shopping are countless- consumers can access stores that may be geographically remote, can order items not otherwise in stock or available at a local store, can quickly compare items from a number of stores, and can often pay less for the same items sold at conventional shopping stores.

Due to the remote and electronic nature of network transactions, just as in conventional catalog ordering most purchases over the Internet are made by credit cards. However, many consumers are concerned about their credit card numbers being transmitted over networks such as the Internet because of the lack of secure communications. Along with the increase of Internet traffic is an increase in opportunity for thieves to intercept credit card numbers for their own personal use. Because credit card transactions over the Internet are not face-to-face, a person having a stolen credit card can charge substantial amounts of goods to that card before the credit card company or consumer is even aware the theft is occurring, which may result in thousands of dollars of losses to the consumer, card issuer, or merchant. Furthermore, each time that credit card information is communicated to a merchant, another opportunity is presented for an unauthorized third party to gain access to the credit card data.

In addition to the possibility that credit card information may be stolen each time the information is submitted to a merchant over the network, the use of a credit card also enables merchants to store information such as the consumer's name, shipping address, and credit card information. After the information has been conveyed only once it can remain on file with the merchant within a customer database. Although this provides some advantages, such as the fact that for subsequent purchases the customer need not communicate their credit card number to the merchant, this also results in some undesired consequences. For instance, many merchants use this information for solicitation purposes, which is an inconvenience to many consumers. Additionally, merchants often also sell or provide this information to other entities who use the information to their own advantage, and without consumer consent. Further, the more purchases a consumer makes, the more physical locations where their credit and personal information is stored will be created. This increases the exposure the consumer has to fraudulent use of this data by, for example, a person that gains unlawful access to the data stored in the merchant's storage facilities.

A number of attempts have been made to alleviate the problem of data protection over networks such as the Internet. For instance, many prior art systems attempt to encrypt credit card numbers at the consumer's computer, prior to transmission over the network. Once the data has been encrypted it is transmitted over the network to the desired location, and decrypted and accessible to the receiving party. Credit card numbers can be encrypted using any of several techniques, such as public key encryption and SSL. However, applying encryption techniques when transmitting credit card numbers requires a merchant to have access to the proper decryption software. Furthermore, encryption may also be overcome by those persons with the ability to intercept credit card numbers transmitted over the network. Therefore, although encryption technology exists to protect consumer to merchant transactions, protecting information that is traded with transaction partners remains difficult.

In addition to problems faced by consumers in transactions over networks such as the Internet, merchants also face potential losses and liability due to fraud. For example, a person using a stolen credit card number may purchase items of value from a merchant, who then provides the items to the thief. When a credit card company refuses to pay the merchant because the merchant accepted credit card payment over the network without proof of identity, the merchant will be forced to incur loses for the value of the items.

What is therefore needed is a system and method that protects consumers and merchants alike from the potential theft of credit card information during transactions, particularly, Internet transactions.

### SUMMARY OF THE INVENTION

The present invention can take blocks of consumer credit card numbers and create dynamic mappings of the card numbers to account numbers or other card numbers, such as pseudo-random credit card numbers. According to one aspect of the invention, the systems and methods of the present invention generate “pseudo-random” credit card attributes, which are presented to merchants at the time of purchase for Internet, telephone, or mail order purchases. The pseudo-random attributes are used by consumers in place of the consumer's credit card. Because pseudo-random attributes are transmitted to the merchant, the transaction between the consumer and merchant will be anonymous. Pseudo-random attributes include the card number, name, billing zip code, expiration date, and purchase amount, each of which can be used singularly or in combination by an authentication server to authenticate a transaction according to consumer preferences, which are captured when the consumer establishes an agent relationship with systems of the present invention. Because of the unique nature of the relationship between the authentication server, the consumer, and data associated with the consumer or consumer's credit card, the systems and methods of the present invention can authenticate the consumer in order to verify their cardholder or account holder status for transactions made with the systems.

The systems and methods of the present invention offer a number of benefits to all parties to the transaction. For instance, fraud is prevented by the nature of dynamic mapping of credit card numbers to pseudo-random attributes and by the additional authentication mechanisms, most of which are configurable by the consumer. Furthermore, the system does not require merchant participation, or changes in the existing payment infrastructure. Additionally, the flexibility, configuration options, and transparent security method benefits the consumer by allowing them to configure their card numbers for multiple usage scenarios with various levels of security and features such as notification. Also, since the process does not require changes in infrastructure from all parties involved, the service can be rapidly adopted and used.

According to one embodiment of the invention, there is disclosed a credit transaction system for facilitating an anonymous credit transaction. The system includes an anonymous transaction server (ATS), which includes an anonymous card generator that generates an anonymous credit card corresponding to a consumer's true credit card, and at least one table that associates the consumer's true credit card with the anonymous credit card. The system also includes a merchant, in communication with the ATS via the credit transaction system. According to the system, the consumer requests a purchase from the merchant using the anonymous credit card, the merchant communicates with the ATS to process a payment for the purchase from the anonymous credit card, and the ATS facilitates a disbursement to the merchant of the payment from the consumer's true credit card.

According to one aspect of the invention, the ATS uses the at least one table to determine the consumer's true credit card from the anonymous credit card. According to another aspect of the invention, the anonymous credit card generated by the anonymous card generator comprises a plurality of anonymous credit card attributes, wherein at least one anonymous credit card attribute is communicated to the merchant from the ATS. The anonymous credit card generated by the anonymous card generator can also include a plurality of anonymous credit card attributes, and wherein at least one anonymous credit card attribute is communicated to the merchant from the consumer.

According to a further aspect of the invention, at least one of said plurality of anonymous credit card attributes is a routing attribute, the merchant uses the routing attribute to communicate with the ATS. Furthermore, the merchant can be in direct communication with the ATS. Moreover, the system can include a bank associated with the ATS, and in communication with the ATS and the merchant. The merchant can also communicate with the ATS via the bank.

According to another aspect of the invention, there is disclosed a system for enabling a consumer to purchase goods and services from a merchant while maintaining the confidentiality of a consumer's true credit card number. The system includes an anonymous transaction server (ATS) that receives true credit card attributes corresponding to the consumer's true credit card and produces an anonymous credit card having at least one anonymous credit card attribute, and a merchant, from which the consumer can purchase goods or services by providing the merchant with at least one anonymous credit card attribute. The system further includes a bank in communication with the merchant and ATS, wherein the bank receives a request for funds from the merchant for a value of the goods or services to be purchased by the consumer, requests the true credit card attributes from the ATS, and receives in return the true credit card attributes from the ATS, after which the bank processes the credit transaction and releases funds to the merchant.

According to one aspect of the invention, the at least one anonymous credit card attribute comprises a routing attribute. According to another aspect of the invention, the routing attribute directs the merchant's request for funds from the merchant to the bank. Alternatively, the routing attribute can direct the merchant's request for funds from the merchant to the ATS. According to yet another aspect of the invention, the merchant is not aware that the anonymous credit card is not the consumer's true card number.

According to a further embodiment of the invention, there is disclosed a method for enabling a consumer to purchase goods and services from a merchant, while maintaining the confidentiality of the consumer's credit card information. The method includes the steps of: receiving true credit card attributes from the consumer, the true credit card attributes corresponding to the consumer's true credit card and including at least one routing attribute; storing the true credit card attributes; producing anonymous credit card attributes associated with the true credit card attributes, wherein at least one anonymous credit card attribute is different from at least one true credit card attribute; providing at least one of the anonymous credit card attributes to the consumer for use in a credit transaction; and mapping at least one of the anonymous credit card attributes to at least one of the true credit card attributes to identify the true credit card attributes.

According to one aspect of the invention, the anonymous credit card attributes include at least one routing attribute identical to the at least one routing attribute of the true credit card. According to another aspect of the invention, the anonymous credit card attributes include a pseudo-random generated number. Additionally, according to one disclosed method, producing anonymous credit card attributes comprises receiving anonymous card configuration options from the consumer, wherein the configuration options identify the appropriate uses of the consumer's true credit card.

According to yet another embodiment of the invention, there is disclosed an anonymous transaction server (ATS) for enabling a consumer to purchase goods and services from a merchant while maintaining the confidentiality of their true credit card information. The ATS includes an interface for receiving from the consumer true credit card attributes indicative of a true credit card of the consumer, a database for storing the true credit card attributes received from the interface, and a processor that generates anonymous credit card attributes including at least one attribute differing from the true credit card attributes, and maps the anonymous credit card attributes to the true credit card attributes using the database.

According to one aspect of the invention, the ATS further includes an interface for receiving from the consumer configurable options that identify the conditions under which the true credit card can be used. Additionally, the ATS of the present invention may be accessible via the Internet, and may notify the consumer when the true credit card is charged.

### BRIEF DESCRIPTION OF THE DRAWINGS

FIG. 1 shows a block diagram of a system in accordance with an embodiment of the present invention, including a consumer, an anonymous transaction server, a bank, and a merchant.

FIG. 2 shows an illustrative anonymous credit card, according to one aspect of the present invention.

FIG. 3 shows a flow chart including in accordance with two methods of the present invention, wherein an anonymous credit number is established to facilitate an anonymous transaction.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

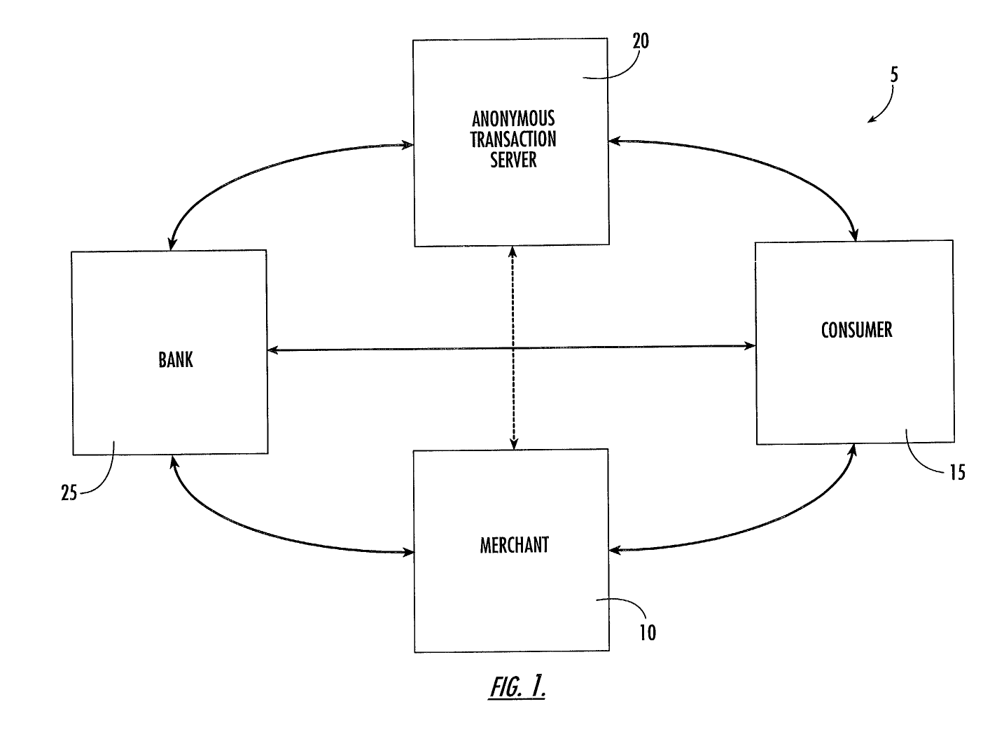

FIG. 1 shows a block diagram of a system 5 according to one embodiment of the present invention, including a merchant 10, a consumer 15, an Anonymous Transaction Server (ATS) 20, and a bank 25. The system is representative of any network through which consumers access merchants for the purchase of goods or services, such as via conventional telephone networks, computer networks, or the Internet. Similarly, the individual components 10, 15, 20, 25 can be components of separate networks in communication with each other through telephone or computer networks, or a combination thereof. For example, according to one aspect of the present invention, a consumer 15 may be in communication with a merchant 10 via an Internet connection, wherein the merchant 10 offers goods for sale via a webpage accessed by the consumer through an Internet connection, such as provided by an Internet Service Provider (ISP). As will be appreciated by those of skill in the art, the modes of communication between the entities of the system 5 of FIG. 1 may be accomplished by any well known communication means, and are not limited to any particular means stated herein. Furthermore, although the present invention will be described herein relative to the Internet, its application is not so limited and is intended to be used on any distributed system in which merchants and consumers interact for the purpose of supplying and purchasing goods or services through credit transactions.

As will be appreciated by those of skill in the art, three components, the merchant 10, consumer 15, and bank 25, in the system 5 illustrated in FIG. 1 are representative of components which interact to facilitate conventional credit transactions. For instance, in conventional credit transactions a consumer 15 can purchase goods and services from a merchant 10 using a credit card received from a credit card provider or bank 25, typically, a card issuing bank. The consumer 15 pays for a purchase by providing the merchant 10 with a credit card, which includes, among other information, credit card attributes which include the credit card number (including routing information or attributes), an expiration date, and the consumer's 15 name. To charge the consumer 15 the merchant 10 communicates with the bank 25 and requests that the bank 25 pay for the transaction amount on behalf of the consumer 15. Using the credit card attributes transmitted to the bank 25 from the merchant 10, the bank 25 determines if the card is valid and if the account status is acceptable (e.g., transaction does not exceed credit available). If the bank 25 deems that the card is valid and the account status is acceptable, the bank 25 will release funds to the merchant 10, typically either immediately or at the end of the day. The merchant 10 then delivers the goods or services to the consumer 15, and the bank 25 charges the consumer 15 for the cost of the goods. This conventional system benefits each of the parties to the transaction. The consumer 15 can make purchases on credit and pay for the purchases at a later time, the merchant 10 can conduct more business due to the popularity of credit cards amongst consumers, and the bank 25 can charge interest for credit charges not paid immediately to the bank by consumers.

Although the basic transaction described above currently takes place between consumers and merchants shopping in conventional ‘brick and mortar’ stores as well as Internet shopping, the system results in a number of disadvantages. Primarily, with respect to card-not-present transactions (i.e., where a consumer does not physically hand his or her card to a merchant), there is a great risk that credit card attributes will be intercepted by a party who will use it fraudulently. This could occur, for example, when consumers use telephone or Internet mail order services, and transmit their credit card number to a merchant who may be geographically remote to the consumer. Another disadvantage is that once merchants obtain credit card information, merchants can use or sell the information to persons who may use the information for solicitational purposes, which is an inconvenience to many consumers.

The Anonymous Transaction Server (referred to hereinafter as the “ATS”) 20 of the present invention, illustrated in FIG. 1, is a component which enables a consumer to transact business with a merchant while concurrently preventing the merchant 10 from obtaining a consumer's 10 true credit card information, such as credit card number, name of card holder, expiration date, issuing bank, and the like. According to the present invention, the ATS 20 is transparent to the merchant 10, and can be utilized without requiring the merchant 10 to incorporate any added features to its existing credit transaction software and/or hardware. As with the other components of the system 5, the ATS 20 may be in communication with other elements of the systems via any communication means known to those of skill in the art.

Briefly, a consumer 15 who wishes to transact anonymously with a merchant 10 can communicate with the ATS 20 and input their true credit card information (referred to herein as true credit card attributes) and configuration options The configuration options, which are discussed in detail below, allow the consumer to identify the conditions under which the anonymous credit card can be used to charge the consumer's true credit card. The ATS 20 then generates a pseudo-random anonymous credit card, which includes routing attributes or other attributes indicating that the credit card has been produced by the ATS 20. According to one preferred embodiment, the ATS 20 would exist in the system as a branch of any affiliated bank to facilitate transaction processing. The ATS 20, using conventional memory and databases implemented via a computer or computer system, stores the consumer's 15 true credit card attributes (e.g., credit card number, expiration date, card holder's name, etc.) and maps the consumer's true credit card attributes to pseudo-random anonymous credit card attributes provided to the consumer 15 by the ATS 20. The ATS 20 thereby substitutes a consumer's true credit card with an anonymous credit card, usable by the consumer, so that the ATS 20 is the only entity that can recognize the consumer 15 by the pseudo-random anonymous card (‘anonymous card’).

By providing a consumer an anonymous card and mapping that anonymous card to the consumer's true credit card, the ATS 20 of the present invention enables a consumer to utilize the anonymous card to transparently transact with a merchant 10. As in a conventional credit transaction, the merchant 10 accepts the anonymous card number from the consumer for processing, without the knowledge that the anonymous card was generated by the ATS 20 of the present invention as opposed to being generated by a credit card provider or a card issuing bank. In processing a transaction involving the anonymous card, the anonymous credit card's routing attributes will cause the transaction information to be delivered either directly or indirectly to the ATS 20 for processing. For instance, the transaction information may be transmitted to the ATS through an identifiable branch ID associated with the ATS (where the ATS operates as a financial institution) or, through an identifiable branch ID for a bank affiliated with the ATS 20. The ATS 20 then determines configuration options associated with the anonymous card number, such as whether the transaction amount is acceptable and whether the card is still active, options that might be selected by the consumer 15, as described in detail below. Alternatively, the ATS 20 may be unable to verify the card number as a anonymous card, and will refuse to complete the transaction. Finally, if the ATS 20 has verified the acceptability of the transaction, the ATS 20 will determine the true credit card number from the anonymous card attributes, and will transmit the consumer's 15 true credit card number with the requisite transaction information to the bank 25. The bank 25 then processes the transaction as any typical credit card transaction.

According to one aspect of the invention, the ATS 20 can comprise a website or webserver, and preferably includes a consumer interface, a database or table for storing true credit card attributes, and a processor (also referred to as an anonymous card generator) for generating pseudo-random anonymous card attributes. The processor also controls the functioning of the ATS 20, such as the mapping of anonymous cards to true credit cards.

Although the merchant may communicate directly with the ATS 20, as noted above, in one embodiment of the invention the ATS 20 may only be accessed through a bank 25 affiliated with the ATS 20, where the bank is a credit card provider of the consumer 15. In this embodiment, the ATS 20 generates an anonymous credit card having attributes indicating that the anonymous card has been produced by the ATS 20. Therefore, when the merchant requests the transaction to be processed, a credit card provider, such as a bank 25 affiliated with the ATS 20, receives the request and identifies the card as being an anonymous credit card for which it must contact the ATS 20 for identification information. Because the bank 25 receives anonymous card attributes from a merchant 10, and must recognize the card as generated by the ATS 20, it may be necessary for the ATS 20 and bank to have some pre-existing relationship or affiliation to establish conditions and/or identifiers so that the bank 25 will accept the anonymous card and will know to contact the ATS 20 to receive the consumer's true card attributes, or have the ATS 20 redirect the transaction to another bank or credit card provider which is obligated to pay the merchant on behalf of the consumer. Therefore, after the true credit card attributes are retrieved by the ATS, this information is transmitted to the bank 25 where the bank is the credit-card issuing entity.

In this embodiment it should be appreciated that because the merchant's request for funds is fulfilled by the bank 25, the ATS 20 is transparent to the merchant 10. This implementation is advantageous because it does not require that a consumer open a new account or line of credit with the ATS 20 or a bank or credit card provider. Furthermore, this implementation allows the consumer to create an anonymous card mapped to existing credit cards already established by the consumer. In essence, this process is a translation service. One drawback with this embodiment is that a nominal fee may be incurred by the consumer to cover the costs of additional network transactions, due to the fact that the transaction traverses the payment network twice.

According to another embodiment of the present invention, since the ATS 20 may be a partner of a financial lending institution, the consumer 15 may open a new credit card account with the partner of the ATS 20. Under this concept, the ATS 20 and the partnering or affiliate bank would open a new credit account for a registered consumer using the ATS 20. A dynamic mapping of anonymous card attributes could be made to the new account. Using the mappings to the ATS/affiliate bank account would only require a credit payment transaction to traverse the system 5 a single time, potentially reducing the cost of processing the transaction for the ATS 20, bank 25, and consumer 15. This implementation may require more sophisticated relationships and hardware and/or software, due to the fact that the anonymous card attributes are not wholly maintained within the ATS, which is accessed by the bank 25 (as in the previous embodiment), but rather maintained in a new account established by both the ATS and bank 25 (or similar entity). This new account could be local or nonlocal to the bank or ATS, and as a result, increased costs may be incurred to maintain this embodiment.

According to yet another embodiment of the present invention, the ATS 20 can function as an independent bank or a credit card provider, so that the ATS 20 is not required to set up a relationship with a bank 25 or like entity. However, in this embodiment the ATS 20 would need to establish credit card accounts with consumers, and would function in many respects just like a credit card issuing bank. In this case, the merchant may communicate directly with the ATS 20, as illustrated by the dotted line in FIG. 1. In this embodiment, to process the payment, a transaction would go directly to the ATS 20, where the true credit card number is determined, and the transaction is facilitated. This is distinguishable from the two above embodiments, where transactions are processed via the bank 25. Therefore, as will be appreciated by those of skill in the art, according to the present invention, the ATS 20 can be either a credit card processing facility, a credit card provider, or partnered with a bank.

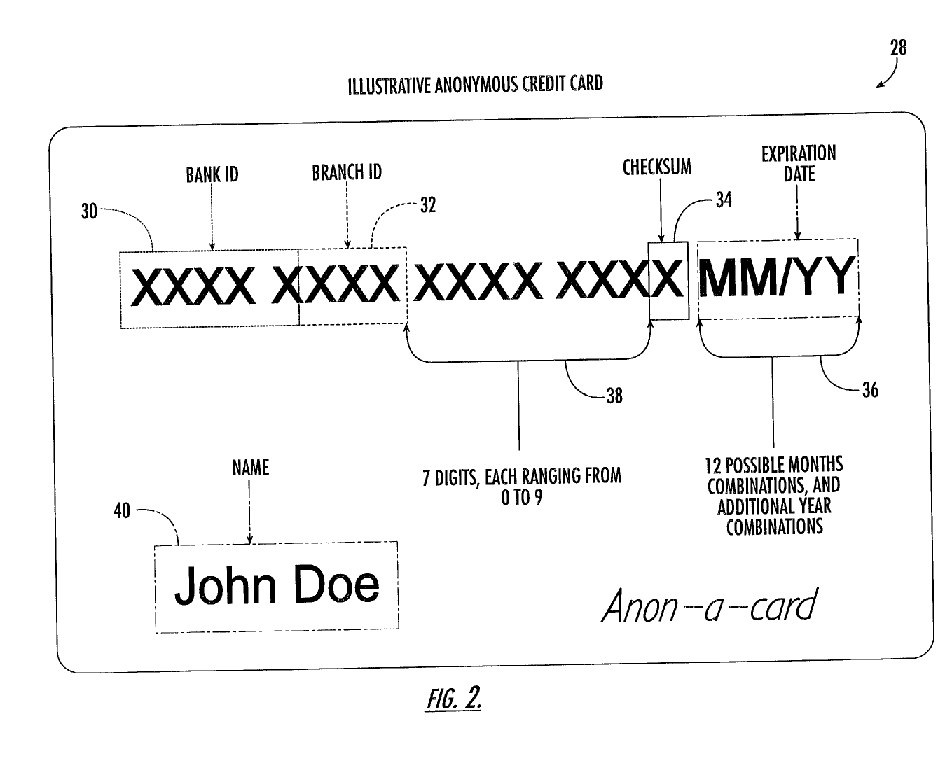

Because the anonymous credit card may be used for remote purchasing via the Internet, catalog ordering, and the like, the anonymous credit card does not necessarily exist as an actual credit card. Instead the anonymous card can be comprised of entirely of anonymous card attributes, such as numbers and data. For purposes of illustration, FIG. 2 shows an anonymous credit card 28, including digits 34, expiration date 36, and name 40 attributes for the purpose of identifying the anonymous card. The anonymous card produced by the ATS 20 must include routing attributes capable of routing the processing of the anonymous card to the ATS 20, whether directly routed to the ATS, or via an affiliated bank 25. As illustrated in FIG. 2, the routing attributes typically comprise digits ranging from 0 to 9, and, according to one preferred embodiment, can include the first 7 or 8 digits of the consumer's true credit card. In the illustrative anonymous credit card shown in FIG. 2, the routing attributes comprise a Bank Id 30 and a Branch Id 32. The Bank Id 30 is shown to include the first 5 digits of the anonymous card, and the Branch Id 32 is shown to include the next 3 digits of the card. However, it should be appreciated by those of skill in the art that the routing attributes can comprise any number of digits or data located anywhere on the anonymous card, so long as the routing attributes match the routing attributes of the ATS 20 or the affiliated bank(s) and credit card processing networks can recognize the routing attributes to redirect the transaction processing to the correct location.

As illustrated in FIG. 2, credit cards, such as the anonymous credit card, can further include additional attributes, such as a checksum digit 34 used for card processing, an expiration date 36, name 40, and additional digits 38 that identify the card member's account. Because conventional credit cards typically include 16 digits, including the routing information and a checksum digit, as well as an expiration date comprising two month digits and two year digits, the anonymous credit card 28 may use the remaining attributes (e.g., digits, name, etc.) to identify the anonymous card so that it may be mapped by the ATS to the true credit card.

The illustrative anonymous card of FIG. 2 comprises 16 digits, including 9 digits taken up by routing attributes 30,32 and checksum 34 digits, and 7 digits 38 that remain available for manipulation. Because the digits can range from 0 to 9, the seven digits result in 10 million (10⁷) possible combinations for credit card numbers for each branch of an affiliated bank that is identified as an ATS 20 branch. Additionally, however, many more combinations can be produced if the expiration date 36 is also manipulated by the ATS 20 of the present invention. For example, in addition to the seven digits 38 available for manipulation, the ATS 20 may also set the expiration date 36 for the anonymous card. Because the expiration date 36 can comprise 12 possible months, and 4 possible additional year combinations, credit cards can have one of (10 million*12*4) 480 million number combinations for each ATS 20 branch, which is more than enough combinations to generate unique anonymous card numbers. Furthermore, even an attribute such as the name 40 or billing zip code produced on the anonymous credit card can be manipulated so that the number of available unique anonymous cards becomes effectively infinite. Additionally, if the consumer's name is manipulated it may provide the consumer 15 the benefit that their true name is not known to the merchant 10 with whom he is conducting business.

According to one aspect of the invention, the added benefit of an anonymous credit card would be meaningless if the anonymous credit card number and other anonymous card attributes, such as the name, could be intercepted and used by another party. In such a circumstance, the anonymous credit card would provide no protection to consumers, as charges could be made to the consumer credit card through the use of the consumer's anonymous card. However, the ATS 20 of the present invention provides very flexible and powerful configuration options to prevent unauthorized use. These configuration options, along with anonymous card attributes, such as the anonymous card number, name on the card, expiration date, billing zip code, and transaction amount can provide transaction authentication parameters for robust control of purchase authorizations. Therefore, a consumer can configure the anonymous credit card so that only limited or designated transactions can occur.

For example, configuration options can be used to create anonymous credit cards for specific usage scenarios. According to one aspect of the invention, the anonymous card could be configured to have a maximum number of transactions associated with it, or a maximum number of transactions in conjunction with a usage period. For instance, a card could be configured so that each card number can only be used for one transaction, thus creating in essence a single use credit card. Thus, even if the anonymous card attributes were intercepted by a third party during a transaction, the third party would be unable to use the anonymous card, due to the card being active for only one use. Alternatively, a card could also be configured so that only a specific number of transactions per month, week or day would be allowed. Configuration options could also enable the consumer to indicate the maximum dollar value per transaction, thereby limiting the charge amount allowed per transaction. As can be appreciated by those of skill in the art, configuration options, such as a time period (day, week, month) can be used in combination with virtually any other configuration option. For example, a consumer could provide for the maximum amount of charges to the anonymous card number per month, week or day. For instance, where a consumer wishes to pay for fixed monthly Internet Service Provider (ISP) fees via an internet credit transaction, the consumer could establish an anonymous card that can be used once a month, and only for a particular charge amount to a particular merchant. Yet another configuration option includes a consumer designated time until the anonymous card number or card mapping expires. Therefore, when the card number mapping expires the same consumer cannot use the card number for a significant period, such as a year, or permanently.

Additionally, configuration options can enable a consumer to specify particular notification messages regarding use of the anonymous credit card. For example, a notification of successful usage could be an on or off configuration option controlling whether the consumer is notified via email of successful transactions using the anonymous card. Similarly, notification of unsuccessful usage could also be an on or off configuration option controlling whether the consumer is notified via email of unsuccessful transactions of the anonymous card. Using this function the consumer can be made aware that others have attempted to use the anonymous card so that the consumer can cancel the card or take other steps to prevent its unauthorized use. Notification of expiration could also be an on or off configuration option, which could control whether the consumer is notified via email prior to the card's expiration. Furthermore, the ATS 20 could allow a consumer to utilize the anonymous card for a different existing true credit card, enabling charges made via the anonymous card to be incurred on different credit card accounts. However, because of the ATS's relationship with the consumer, only credit card accounts that are held by the consumer could be mapped to an anonymous card account (i.e., an anonymous card number cannot be mapped to another's anonymous card number). The consumer would also be able to change the mapping of an anonymous card number to an existing card number whenever they desire. For instance, a consumer 15 could map a persistent anonymous card to their Visa Card™ one day and their Discover Card™ the next day.

According to one aspect of the invention, a consumer 15 may select one or more of these configuration options upon logging into the ATS 20 through a graphical consumer interface, such as an interactive webpage, preferably through a secure connection. The ATS 20 can request that the consumer 15 input identification information, such as name, address, social security number, telephone number, as well as additional information to establish consumer identity and contact information. After this information is received, the ATS 20 may present the consumer with a consumer ID and password for subsequent use of the ATS 20 of the present invention. Once a consumer 15 is logged on, the ATS 20 can offer consumers an anonymous credit card having consumer-selectable configuration options, such as those discussed above. The options can be selected by consumers through the use of toggle selections or through any well known method through which consumers can selectively choose an assortment of options. After selecting configuration options, the consumer 15 may enter his or her true credit card attributes, after which the ATS generates an anonymous card for the consumer. This anonymous card information is stored in a relational database or relational table, along with the true credit card attributes, so that the true credit card attributes can be identified by the ATS by the anonymous card attributes and having the consumer selected options. Alternatively, it should be appreciated that the consumer could be required to input credit card information or configurations prior to being able to receive an anonymous card, such as during the consumer's initial login.

Configuration options are also stored by the ATS 20 for each anonymous card, along with the true credit card attributes. This information may be stored in a conventional memory device as are well known in the art, and accessed each time the ATS 20 receives a transaction request. According to one aspect of the present invention, when the ATS 20 receives a request for a consumer's true credit card attributes based upon anonymous card attributes, the ATS 20 can retrieve configuration options corresponding to the anonymous card, and can update the anonymous card attributes depending upon the configuration options as well as the transaction. For example, an anonymous card could be established with options that make the card available for use only twice over a one month period. The first time the anonymous card is used, the configuration options are retrieved from memory to identify whether the transaction is appropriate before the ATS 20 will release the consumer's true credit card number to an entity such as a bank. As long as the configuration options are fulfilled, the ATS 20 forwards the true credit card number to the bank 25 or credit card provider, and the transaction is facilitated. At the same time, assuming the transaction is the first transaction occurring for the two-time use card, a memory associated with the ATS 20 can be updated by the processor to indicate that the card may be only used one more time within that month. Therefore, the next time the anonymous card is used, the ATS 20 will again determine if the transaction is acceptable based upon the configuration options related to the anonymous card, such as time, transaction amount, number of uses, etc. However, because the anonymous card may be used only twice, after the second use, the ATS 20 registers that the card is inactive or unavailable for future uses. Therefore, if a person attempts to utilize the anonymous card a third time, the ATS 20 will indicate that the card is inactive, and will refuse to authorize release of the consumer's true credit card attributes to the requesting bank or credit card provider. As will be appreciated by those of skill in the art, this example is intended to be for illustrative purposes only, and is not intended to limit the functions of the ATS 20 with respect to configuration options.

Alternatively, according to one aspect of the invention, the consumer configuration options could be tied to one or more attributes on the anonymous card that are known to the credit card issuer or a bank. For example, where a card is designated as a one time use card by a consumer, the card may contain an attribute that indicates the card may be used only one time, such as a particular sequence of digits, a particular expiration date, a particular name, or any combination thereof. If these attributes are known to a bank, for example, each time the bank receives a card number having these attributes, the bank, rather than the ATS 20, could determine if the attributes are satisfactory. Although this would require the card issuing bank to maintain a list of attributes corresponding to configuration options, as well as a historical database to track the usage of anonymous cards, this alternative method may be advantageous because it can limit the number of times transactions must pass through the network or system.

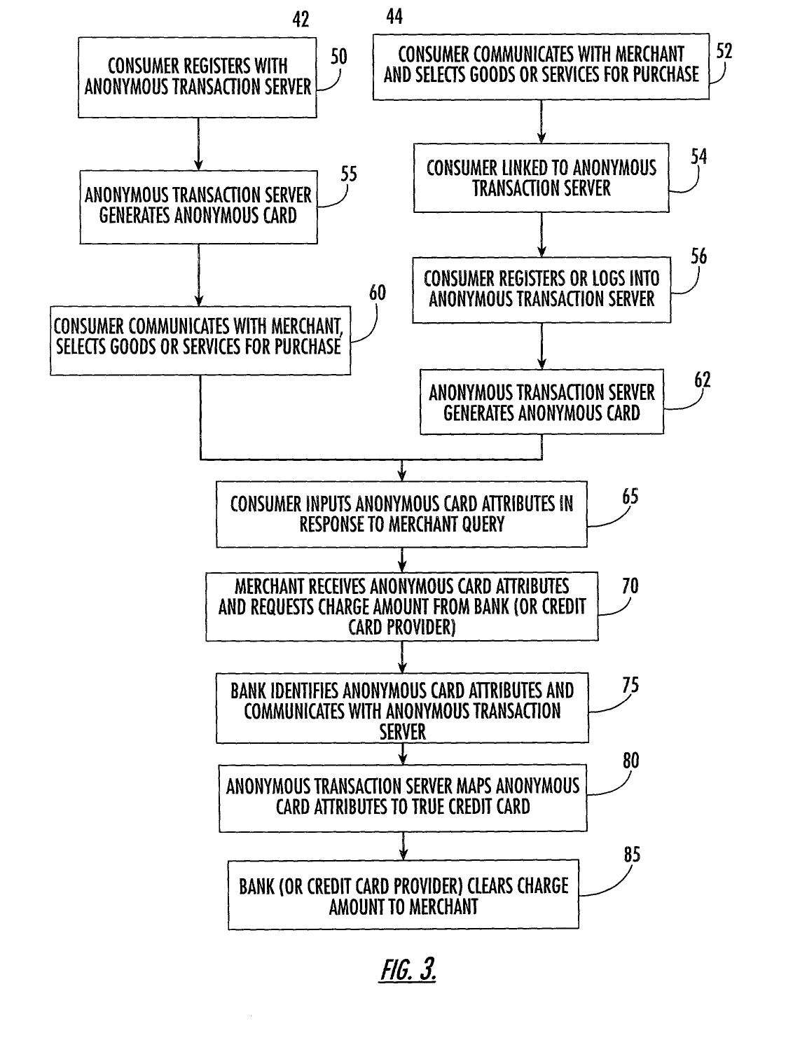

FIG. 3, which shows a flow chart including two illustrative methods where an anonymous credit card is utilized to facilitate an anonymous transaction. The two methods discussed below correspond to reference number 42, discussed first, and reference number 44, discussed second.

According to one embodiment of the present invention (method 42), a consumer can first register with the ATS of the present invention (block 50) prior to shopping over a network, such as the Internet. As stated above, the consumer may be required to register with the ATS, or may simply login to the ATS using a previously provided consumer Id and password. After logging in, a consumer may select configuration options, and can request an anonymous credit card. In response to the consumer's request for an anonymous number, the ATS generates an anonymous card (block 55) that includes the consumer requested configuration options. After obtaining the anonymous card, which can simply be a list of attributes such as a card number, or a card number and name, the consumer is free to use the card, such as by shopping online. After locating a good or service for purchase from a merchant (block 60), the consumer can select to purchase the good or service. In response to a request for purchase, the merchant will request that the consumer enter a credit card number, as well as additional information such as a shipping name and address. The consumer then provides the anonymous card attributes to the merchant (block 65) for processing. Thereafter, as described with respect to FIG. 1, the merchant requests the charge amount from a bank or credit card provider (block 70), where the request was transmitted based upon the routing attributes associated with the anonymous credit card. The routing attributes associated with the anonymous card result in the request being directly transmitted to the ATS 20 of the present invention, as discussed above. Alternatively, the routing attributes may route the request to a bank or credit card provider, and then on to the ATS 20. The ATS 20 then identifies the anonymous card attributes and maps them to the consumer's true credit card (block 80), and forwards this information to the bank, which transmits the charge amount to the merchant or to the merchant's bank (block 85).

According to another embodiment of the present invention (method 44), a consumer need not access the ATS of the present invention to reap the benefits of the present invention. On the contrary, as illustrated in FIG. 3, a consumer can first locate a merchant and select a good or service to be purchased from that merchant (block 52). Thereafter, the merchant can offer the consumer the advantages of the present invention by offering the consumer a link to the ATS (block 54). Although this embodiment may require the merchant to agree to link or offer the ATS on the merchant's site, this embodiment offers the advantage that consumers need not be aware of the ATS prior to entering into transactions over the network. Thereafter, the consumer can register with the ATS of the present invention, and can receive an anonymous card from the ATS in a like manner as described above. Alternatively, the anonymous number may be transmitted directly from the ATS to the merchant.

According to one aspect of the invention, the ATS could obtain the merchant's address or Universal Resource Locator (URL) from the consumer's computer directly. In one such embodiment, the consumer's computer could contain an Hyper-Text Transfer Protocol (HTTP) cookie for both the ATS and merchant, such that the identity and internet address of both entities are stored on the consumer's computer. As is well known in the art, HTTP cookies are packets of information sent by an HTTP server to a browser and then sent back by the browser each time it accesses that server. Cookies can contain any arbitrary information the server chooses and are used to maintain state between otherwise stateless HTTP transactions. Typically this is used to authenticate or identify a registered user of a web site without requiring them to sign in again every time they access that site. Other uses are, for instance, maintaining a shopping basket of goods you have selected to purchase during a session at a site, site personalization (presenting different pages to different users), and tracking a particular user's access to a site. According to this embodiment, the ATS could be accessed on the merchant site and could, through the use of a cookie, identify the merchant and the amount of the product or service to be purchased by the consumer. The ATS could also use the merchant cookie to communicate with the merchant when the ATS has completed processing. Additionally, a cookie located on the consumer computer could also update or provide the merchant with requisite ATS information, such as the ATS's URL, for transaction processing, such that the entire transaction between the merchant and ATS is facilitated through communications which are virtually invisible to the consumer.

Modules also may be written and installed on the merchant's web servers and interoperate with their e-commerce applications to facilitate the generation and/or use of an anonymous card. Then, when a consumer opts to make a transaction with a merchant the consumer can select, via a graphical user interface, to make an anonymous credit payment. After such as selection, a new window can open with the URL to the ATS 20, with the merchant's ID sent as an argument in the URL. The ATS can then communicate securely with the module on the merchant's server to determine the charge amount. The new window that opens is the ATS login screen which requires the consumer to login, verify the charge amount, select a payment method, and approve the transaction. After approving the transaction at the ATS can find the merchant's account, and a verification receipt can be sent to the merchants module so that the merchant can verify that they received payment. Therefore, all that remains is for the merchant to deliver the goods or service. In this scenario, the merchant is never privileged to any account information specific to the consumer, so the consumer is not at risk of accidentally revealing that information. Furthermore, the consumer was authenticated to the ATS, so the identity of the person actually performing the transaction is known to the ATS through registration, as explained above, but not necessarily revealed to the merchant by the ATS. Therefore, the present invention prevents fraud for both the merchant and the consumer, is backwards compatible with existing payment methods, and is extremely secure. Additionally, the present invention features an anonymous, secure payment mechanism, and supports traditional payment methods.

The ATS may also be implemented through the use of an applet or pop-up payment panel, which may be implemented with an object-oriented programming language such as Java developed by Sun Microsystems, Incorporated of Mountain View, Calif. The object oriented programming language that is used should be capable of creating executable content (i.e., self-running applications) that can be easily distributed through networking environments. The object oriented programming language should be capable of creating special programs, typically referred to as applets that can be incorporated in web pages to make them interactive. It should be noted that the chosen object-oriented programming language would require that a compatible web browser be implemented to interpret and run the pop-up payment panel. It is also possible to implement the pop-up payment panel using other programming languages, such as HTML, SGML and XML; however, these languages may not be able to provide all the dynamic capabilities that languages, such as Java, provide.

Therefore, after a consumer selects goods or services to purchase from the network, the consumer can obtain an anonymous credit card, and proceed through the steps indicated by blocks 65, 70, 75, 80, and 85 of FIG. 3, or the process may be streamlined such that the APS of the present invention automatically received the transaction information directly from the merchant. In either event, however, the mapping of anonymous cards to true credit cards enables consumers to maintain their secret identity from the merchant.

Another embodiment of the present invention may be implemented where the ATS or an affiliate bank provides an actual credit card having the anonymous credit card number. This would allow the flexibility that the consumer configurable options provide to translate into the ‘brick and mortar’ world of transaction processing. In one embodiment of this implementation, the consumer 15 requests the ATS 20 to provide them with a credit card with the anonymous credit card number, which may be configured for a particular use, such as an allowance for a child, where up to a preset amount of spending in a certain period (week, month) is set. The card can then be used for any conventional credit card purchase, where the actual payment for the purchase is made in the described method. This embodiment of the system of the present invention allows the anonymous card use to be extended to card-present transactions and allows for an additional layer of security even in card-present transactions.

As will be appreciated by the foregoing discussion, the present invention offers a number of advantages to all parties to the transaction. Consumers can use the system and method of the present invention for any card-not-present transaction (such as mail order and telephone orders), and can configure the anonymous card for one time use, or a multitude of other configurable options, such as the maximum charge per transaction. Additionally, the system and method secures consumer credit attributes to prevent fraud, and depending on the level of security chosen by the consumer, the ATS can also prevent merchants from tracking consumer buying habits. Also, the system can provide consumers with useful notification of certain purchasing events like success or failure of card usage, or card number expiration.

The present invention is also beneficial to the merchant. The system is totally transparent to the merchant, and requires no change in the merchant's payment infrastructure (the merchant does not have to knowingly participate to gain the benefits of the system). Furthermore, the anonymous card transactions will reduce the possibility of fraudulent card activity for the merchant, and thus, less exposure to liability and risk in conducting credit transactions. For instance, where losses stemming from fraudulent use of credit cards may currently fall on the merchants, the system and methods of the present invention may be implemented such that merchants will not incur losses for accepting anonymous credit card numbers, given the authentication method of the present invention. Financial institutions are also benefited by the system and method of the present invention. The system does not require infrastructure changes, and reduces fraud and the costs associated with dealing with such.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A credit transaction system for facilitating an anonymous credit transaction, comprising:
an anonymous transaction server (ATS), including
an anonymous card generator that generates an anonymous credit card corresponding to a consumer's true credit card, and
at least one table that associates the consumer's true credit card with the anonymous credit card; and
a merchant, in communication with the ATS via the credit transaction system, wherein the consumer requests a purchase from the merchant using the anonymous credit card, the merchant communicates with the ATS to process a payment for the purchase from the anonymous credit card, and the ATS facilitates a disbursement to the merchant of the payment from the consumer's true credit card.

2. The system of claim 1, wherein the ATS uses the at least one table to determine the consumer's true credit card from the anonymous credit card.

3. The system of claim 1, wherein the anonymous credit card generated by the anonymous card generator comprises a plurality of anonymous credit card attributes, and wherein at least one anonymous credit card attribute is communicated to the merchant from the ATS.

4. The system of claim 1, wherein the anonymous credit card generated by the anonymous card generator comprises a plurality of anonymous credit card attributes, and wherein at least one anonymous credit card attribute is communicated to the merchant from the consumer.

5. The system of claim 4, wherein at least one of said plurality of anonymous credit card attributes is a routing attribute, and wherein the merchant uses the routing attribute to communicate with the ATS.

6. The system of claim 1, wherein the merchant is in direct communication with the ATS.

7. The system of claim 1, further comprising a bank associated with the ATS, and in communication with the ATS and the merchant.

8. The system of claim 7, wherein the merchant communicates with the ATS via the bank.

9. A system for enabling a consumer to purchase goods and services from a merchant while maintaining the confidentiality of a consumer's true credit card number, comprising:
an anonymous transaction server (ATS) that receives true credit card attributes corresponding to the consumer's true credit card and produces an anonymous credit card having at least one anonymous credit card attribute;
a merchant, from which the consumer can purchase goods or services by providing the merchant with at least one anonymous credit card attribute; and
a bank in communication with the merchant and ATS, wherein the bank receives a request for funds from the merchant for a value of the goods or services to be purchased by the consumer, requests the true credit card attributes from the ATS, and receives in return the true credit card attributes from the ATS, after which the bank processes the credit transaction and releases finds to the merchant.

10. The system of claim 9, wherein at least one anonymous credit card attribute comprises a routing attribute.

11. The system of claim 10, wherein the routing attribute directs the merchant's request for finds from the merchant to the bank.

12. The system of claim 10, wherein the routing attribute directs the merchant's request for funds from the merchant to the ATS.

13. The system of claim 9, wherein the merchant is not aware that the anonymous credit card is not the consumer's true card number.

14. A method for enabling a consumer to purchase goods and services from a merchant, while maintaining the confidentiality of the consumer's credit card information, comprising:
receiving true credit card attributes from the consumer, the true credit card attributes corresponding to the consumer's true credit card and including at least one routing attribute;
storing the true credit card attributes;
producing anonymous credit card attributes associated with the true credit card attributes, wherein at least one anonymous credit card attribute is different from at least one true credit card attribute;
providing at least one of the anonymous credit card attributes to the consumer for use in a credit transaction; and
mapping at least one of the anonymous credit card attributes to at least one of the true credit card attributes to identify the true credit card attributes.

15. The method of claim 14, wherein the anonymous credit card attributes include at least one routing attribute identical to the at least one routing attribute of the true credit card.

16. The method of claim 14, wherein the anonymous credit card attributes include a pseudo-random generated number.

17. The method of claim 14, wherein producing anonymous credit card attributes comprises receiving anonymous card configuration options from the consumer, wherein the configuration options identify the appropriate uses of the consumer's true credit card.

18. An anonymous transaction server (ATS) for enabling a consumer to purchase goods and services from a merchant while maintaining the confidentiality of their true credit card information, comprising:
an interface for receiving from the consumer true credit card attributes indicative of a true credit card of the consumer;
a database for storing the true credit card attributes received from the interface; and
a processor that generates anonymous credit card attributes including at least one attribute differing from the true credit card attributes, and maps the anonymous credit card attributes to the true credit card attributes using the database.

19. The ATS of claim 18, further comprising an interface for receiving from the consumer configurable options that identify the conditions under which the true credit card can be used.

20. The ATS of claim 18, wherein the ATS is accessible via the Internet.

21. The ATS of claim 18, wherein the ATS notifies the consumer when the true credit card is charged.
